(19) United States
(12) Patent Application Publication
(10) Pub. No.: US 2015/0259924 A1
(43) Pub. Date: Sep. 17, 2015

(54) HANGING DRIP EDGE

(71) Applicant: Joseph R. Van Biber, Blue Springs, MO (US)

(72) Inventor: Joseph R. Van Biber, Blue Springs, MO (US)

(21) Appl. No.: 14/217,451

(22) Filed: Mar. 17, 2014

(51) Int. Cl. E04D 13/04; F16M 13/02

(52) U.S. Cl. CPC E04D 13/0459; F16M 13/02; E04D 2013/0468

(57) ABSTRACT

The present invention provides an improved hanging rain cover for directing moisture received by a horizontal structure away from a vertical structure while hanging a house hold object upon a hanger received by at least one receiver extending along a angled surface extending from a substantially planar surface which at least partially obscures the house hold object.

### CROSS-REFERENCE TO RELATED APPLICATION

This application claims the benefit of the prior filed U.S. provisional application No. 61/783,739 filed Mar. 14, 2014 which is incorporated herein by reference.

### FIELD OF THE INVENTION

The present invention is generally directed towards covers for static structures and in particular to rain covers for building structures having a depending hanger for receiving various non-structural elements.

### BACKGROUND OF THE INVENTION

Gutters and downspouts are mounted on most residential and commercial structures along the lower edge of the roof of the structure to receive water draining off of the roof, such as during a rainstorm. Gutters come in many different styles, including K gutter, half round gutter, or commercial box gutter, but all are generally formed with an open top through which water is received into a trough or channel that delivers the water by gravity to a downspout for discharge away from the building structure. The presence of leaves and debris in the gutter trough will often clog the gutter and the downspout, preventing water from draining down the downspout and away from the building structure. Gutters are often mounted on a plurality of hangers that are spaced along the length of the gutter and fastened to fascia boards by nails or screws such that the gutter is suspended from the hangers.

Gutter covers are mounted on the top of the gutter, usually by screws spaced along the length of the front lip of the gutter. Gutter covers come in many configurations. Some have openings in the cover for water to pass into the gutter trough, while others are solid with a curved front edge that allows water to follow the curve into the gutter trough while leaves and debris are discharged off the cover away from the gutter. One such gutter cover can be seen in U.S. Pat. No. 6,672,012, wherein the curved front edge allows water to pass into the gutter trough. This gutter cover disclosed in the '012 patent is mounted under the shingles at the roof line to extend over the gutter trough. Some gutter covers combine the solid configuration with a curved front end and an apertured portion, such as is found in U.S. Pat. No. 6,883,760, where the gutter cover is mounted under the shingles and provides a portion with holes to allow the passage of water off the rounded nose into the gutter trough. A similar gutter cover, but having holes through the entire cover, is found in U.S. Pat. No. 6,944,991.

Other gutter covers, such as is disclosed in U.S. Pat. No. 6,067,755, simply form a cover that extends from the roof line directly to the front lip of the gutter with the body of the gutter cover being farmed with diagonal slots that allow the passage of water into the gutter trough. Not all gutter covers are mounted under the shingles at the roof line, as can be seen in U.S. Pat. No. 5,737,879, where the roof side of the gutter cover is fastened by nails to the fascia board underneath the roof edge. A solid gutter cover with a rounded front edge can also be mounted to the gutter, as is disclosed in U.S. Pat. No. 4,604,837, where the back edge of the gutter cover is fastened to the gutter and to the fascia board by nails passing through the gutter and gutter cover.

In U.S. Pat. No. 6,412,228, the gutter cover is formed with a rounded front edge to urge water into the gutter trough, but also incorporates a drip lip at the forward edge of the gutter cover to direct water away from the front face of the gutter. A second drip lip is provided under the gutter cover to direct water coming through the gutter cover into the trough instead of along the fascia board. This drip edge, as well as the gutter cover is mounted underneath the shingles at the front edge of the roof.

### SUMMARY OF THE INVENTION

Various embodiment of the present invention include a gutter cover generally secured to a structure with a hanger attachment. The gutter has a back wall and a front wall in receipt of the rain guard. The rain guard generally includes a planar body congruous with a shoulder extending to a throw for diverting rain from the roof and away from the structure. The throw is adapted for receipt of a hanger, the hanger being received in one embodiment frictionally and in other embodiments in mechanically received at a hanger receiver. Various hangers are illustrated into the referenced drawings as well as various planer bodies in association with the gutter.

In one embodiment of the present invention, an improved hanging rain cover adapted for directing moisture received by a horizontal structure away from a vertical structure while hanging a house hold object includes a substantially planar body having at least on rib extending longitudinally therethrough, said rib securing said improvement to said horizontal structure, a shoulder being generally contiguous with said substantially planar body and presenting a downwardly depending throw whereby moisture is directed from said horizontal structure by said substantially planar body and angularly away from said vertical structure by said throw, at least one receiver extends through and is spaced along said throw for receiving a hanger presenting a projection for receiving the house hold object whereby said house hold object is at least partially obscured by said throw in receipt of said hanger. The house hold objects may include but are not limited to a cables, cords, decorations, window shades, wind chimes, and exterior lighting but may extend to generally known household items extended horizontally along the roof or other horizontal structures.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a perspective view of an embodiment of the hanging rain guard in association with building fascia in accordance with the present invention.

FIG. 2 is a perspective view of an embodiment of the hanging rain guard covering at least a portion of a gutter in accordance with another embodiment of the present invention.

FIG. 3 is a perspective view of another embodiment of the hanging rain guard in association with a gutter in accordance with another embodiment of the present invention.

FIG. 4 is a partially exploded upper perspective view of the embodiment of FIG. 3 with a removable hanger and complementary hanging structure on the gutter guard.

FIG. 4a is a perspective view of an embodiment of the hanging rain guard of FIG. 3 in receipt of an alternative hanging clip.

FIG. 5 is a side view of the hanging rain guard clip of FIG. 4.

FIG. 6 is a bottom view of the hanging rain guard of FIG. 3.

FIG. 7 is a perspective view of an alternative embodiment of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring now to FIGS. 1-7, there are several similar embodiments of the improved hanging rain cover incorporating the principles of the present invention. In each embodiment of the invention, the rain cover, also referred to herein as the rain guard, 10 is associated with a roofing structure 2 to divert rain discharged off of the roof 2 of the building away from the drip line (not shown) of the structure. The rain cover 10 conceals and improves the stability of hung objects, such as wires or decorations, while providing and improved visual appearance. In one embodiment, the rain cover 10 attaches above the fascia 4 and diverts water away from the drip line of the building structure (not shown). In some cases, the invention also includes a means to limit the entry of leaves and other debris into a trough 32 of a rain gutter 30. If too much debris is present it could potentially clog the gutter 30 and inhibit the drainage of rain water therefrom. Although the illustrated embodiments include a typical trough-style gutter 30, other gutters may be used including a K-gutter, half-round gutter or commercial-box gutters, all of which are formed with upright sidewalls (not shown). A typical gutter includes a rear edge 37 attached to the vertical building structure such as fascia 4 and a front face or a front lip 34 is spaced from the rear edge 37 by a trough 32 into which rain water falls and is carried away.

As illustrated in FIG. 1, an embodiment of the present invention, the rain guard 10 associated with the structural fascia 4, includes the substantially planar body 16 having one or more raised ribs 14 extending longitudinally therethrough. Each raised rib 14 helps channel the received rain-water and is directed perpendicularly to the planar body 16 with a pointed edge 15 extending therealong which may secure the rain guard 10 in place, along the edge of the roof structure 2.

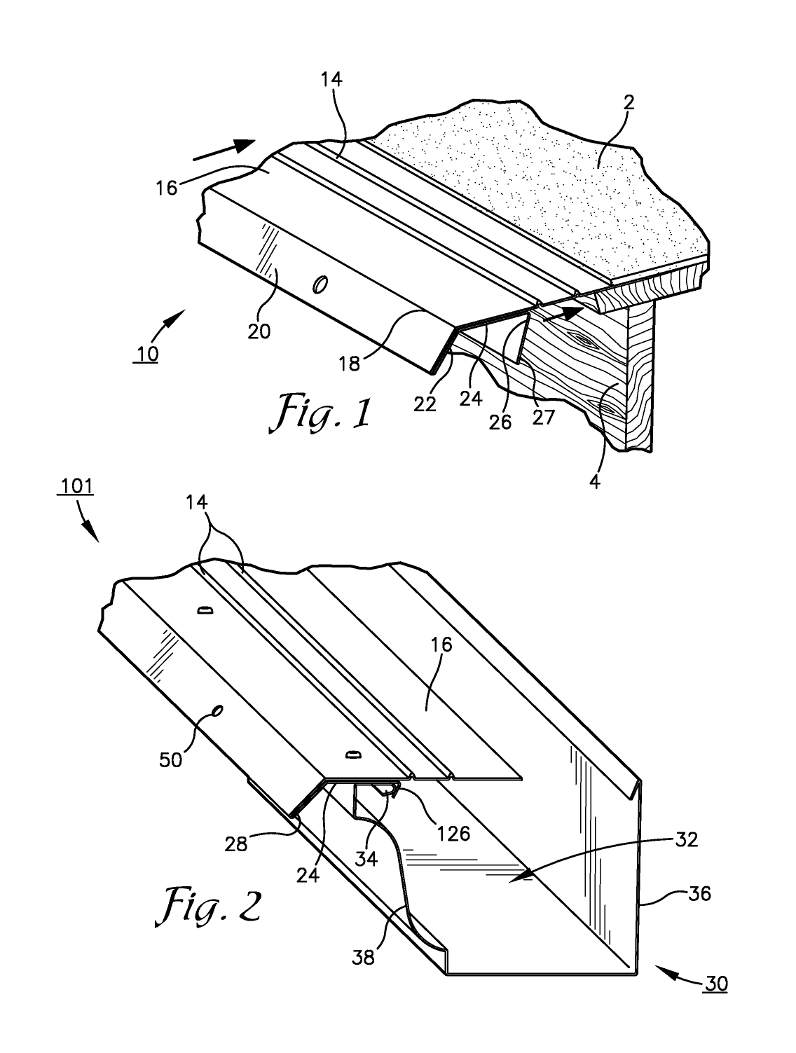

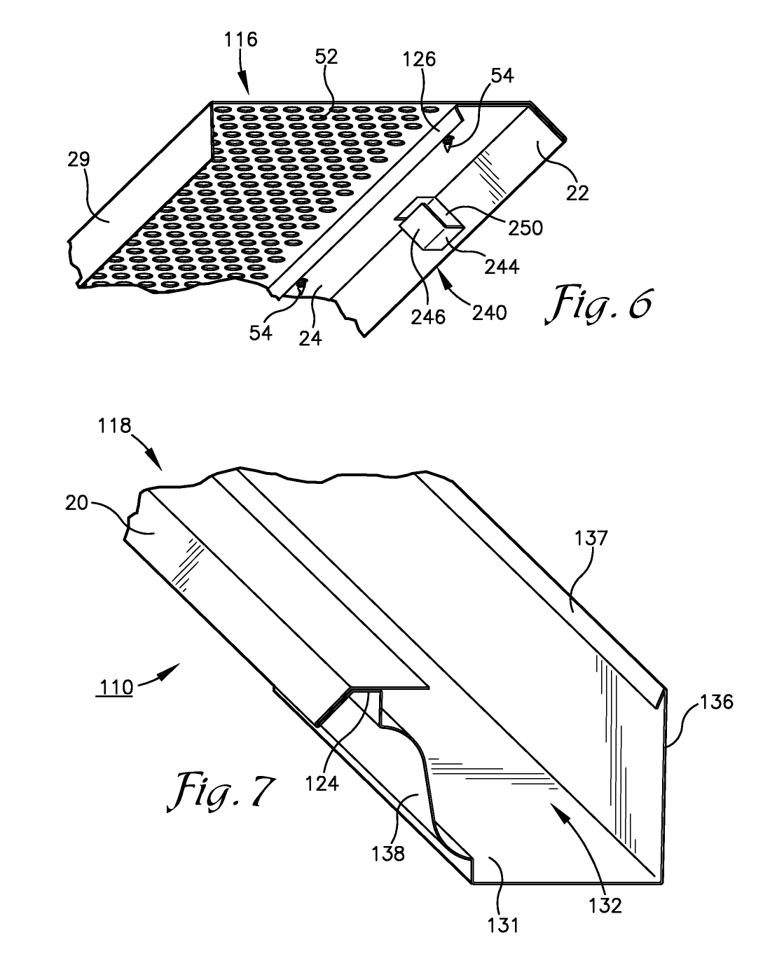

Contiguous with the substantially planar body 16 and extending longitudinally therewith is a shoulder 18 presenting a downwardly depending throw 20. The throw 20 extends obtusely from the shoulder to direct any moisture away from the building structure and the gutter 40, along the drip line at the ground level. Generally, the improved rain guard 10 extends horizontally outwardly from a gutter 30 at least partially through a trough 32 and over a gutter front wall (front face) 38, extending any accumulated rainwater over the gutter and along the throw or outwardly extended drip edge 20 towards the structure's drip line. The substantially improved rain guard 16 may be secured directly to the roof as depicted in FIG. 1. Alternatively, in another embodiment, the improved rain guard may be mechanically secured to the gutter front face 38 as depicted in FIG. 2. Another embodiment of the present invention illustrates the improved rain guard secured to the gutter front face 38 and a rear wall 36. Another embodiment of the present invention, illustrated in FIG. 7 with an integrated improved rain guard being contiguous with a typical gutter design. An upending wall 22 extends substantially coplanar with the throw 20 and continues towards a generally horizontal support ledge 24 which supports the substantially planar body 16. A backing 26 is further illustrated in FIG. 1, the backing 26 extending vertically from the support ledge 24 towards a lower foot 27. As illustrated, the backing 26 is configured for vertical abutment with surrounding fascia 4 and for horizontal positioning of the throw 20 as desired for desired drainage of any accumulated rain-water draining off the roof or falling on the substantially planar body 16. The lower foot 27 may extend angularly from the fascia 4, such as but not limited to an obtuse angle, to allow any capillary fluids to drain away from the surrounding fascia 4, thereby avoiding accumulation of unnecessary moisture which may cause staining or discoloration. A channel 28 is extending longitudinally and is presented between the juncture of the throw 20 and the upending wall 22. Channel 28 has sufficient dimension to avoid unnecessary moisture accumulation. In one embodiment, as the rainwater travels from the roof, onto the drip edge or throw 20 it is diverted away from the fascia 4 along the drip line of the structure on the surrounding ground surface.

In the illustrated embodiment of FIG. 1, the improved rain cover 10 with the substantially planar body 16 and hanger 40 is applied to horizontal decking member roof 2 for hanging various items (not shown), while projecting any rainfall from the horizontal decking member away from a vertical structure fascia 4 along a drip edge of the structure, while providing the hanger 40, also referenced to herein as a hanging member 40, further described below for use in hanging household objects such as cables, cords, decorations, window shades, wind chimes, and exterior lighting. While the illustrated embodiment is shown in connection with a roof, it could alternatively be applied to a horizontal decking member of a deck for diverting rain-water from the supporting vertical structure.

The alternative embodiment of FIG. 2 includes a downwardly depending catch 126, extending angularly from the supporting ledge 24. The catch 126 is provided for engagement with a front lip 34 associated with a typical roof gutter 30 and as depicted includes a complimentary hook-latch configuration for mechanical connections onto the gutter 30.

The exemplary gutter 30, illustrated in FIG. 2, includes a rear wall 36 for placement near a vertical wall such as fascia 4 and a beveled front wall 38 which together provide a trough 32 for capturing and transporting any moisture from the roof 2 away from the structure 4. The front lip 34 being received by the catch 126 supports and positions the rain guard 10 on the gutter 30. The catch 126 is bent at an acute angle sufficient for engagement with the front lip 34 for positioning the rain guard 10 on the top of the gutter 30, the substantially planar body 16 extending into the opening of the trough 32, protecting the trough 32 from falling debris which may cause the gutter 30 to become clogged.

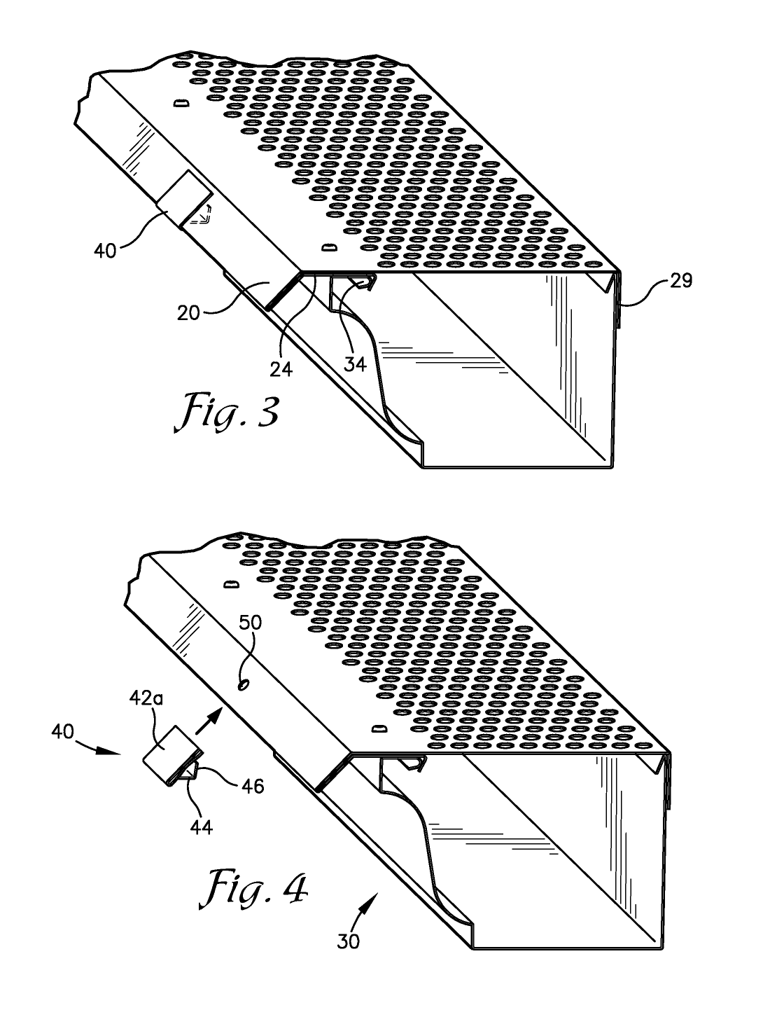

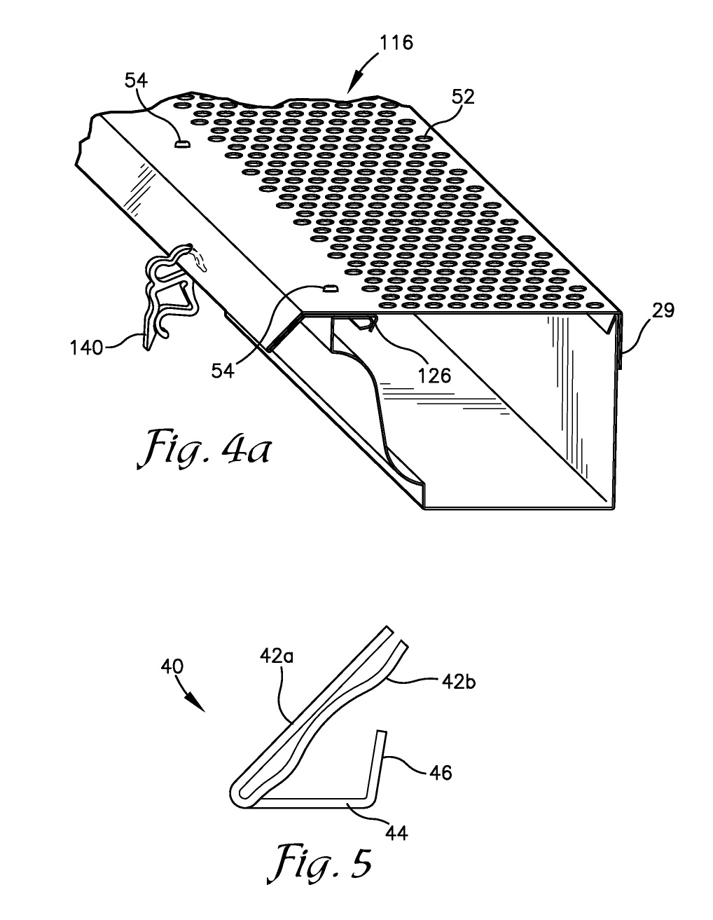

FIGS. 3-4 illustrate a hanging clip, also referred to herein as a hanger, 40 secured to the rain guard 10. FIG. 4a includes an alternative hanging clip 140 secured to the rain guard 10 at the receiver 50. Generally, the hanging clip 40 is adapted for removable receipt by the rain guard 10 for receiving and supporting various household objects with supporting structures such as but not limited to projection 44 as illustrated in FIG. 5. The illustrated hanging clip 40 is depicted in FIGS. 3-4 as being rectangular with an approximately 1″ side, although various shapes and dimensions are considered within the scope of the present invention including but not limited to polygonal, round, or irregular shaped hangers like the hanging clip 140 illustrated in FIG. 4a. The hanging clip 40, 140 may be fabricated from a weatherable material like a plastic, steel, or aluminum while also being paintable to match or contrast other nearby structures.

The hanging clip 40 is further illustrated in FIG. 5 with a frictional configuration including a top clamping member 42a, a bottom clamping member 42b, projection 44 with an upending arm 46. The projection 44 being designed to receive and hang the desired household objects, generally extends at an acute angle in relation to the clamping members 42a, 42b. The upending arm 46 retains the received household objects is generally positioned upright in relation to the projection 44. The upending arm 46 and projection 44 provide the desired structure to removably hang the household objects (not shown) such but not limited to decorations, Christmas lights, banners or flags, hanging baskets, cords or cables.

The top clamping member 42a and bottom clamping member 42b present a generally u-shaped opening for frictional receipt of the throw 20. By way of example, and not as a limitation, the top clamping member 42a presents a generally planar surface, while the bottom clamping member 42b as depicted, provides a frictional engagement with the throw and may be concave or convex or another biased structure for retention of the clip 40 on the throw 20. The hanging clip 140 may utilize a mechanical engagement as depicted in FIG. 4a with a projection 141 of the hanger 140 extending at least partially through the receiver 50 to securely hang household objects on the improved rain guard 10. The hanger 140 includes a first and second irregular projections 142, 144 which are biased towards a closed orientation and may be temporarily extended for receipt of a household object. During receipt of the household object by the interior region 146 of the hanger 140, on of the first and second irregular projections 142, 144 may provide the support to hang the household object. An interior region 146 is generally defined by the first and second irregular projections 142, 144 and is adapted for biased receipt of the hung household object.

Alternatively, a hanging clip may frictionally and mechanically secured upon the improved rain guard 10 with a frictional engaging pair of surfaces, such as the top and bottom clamping members 42a, 42b with the bottom clamping member including an outwardly extending projections (not shown) which may be at least partially received by the hanger receiver 50. In this way the clip 40 may be both mechanically and frictionally secured to the throw 20 and aligned with the receiver 50 while a household object is supported and retained by the projection 44 for removably hanging it upon the improved rain guard 10. During operation, the hanging clip 40 or alternative hanging clip 140 may be received by the rain guard 10 and spaced longitudinally therealong as desired to provide the proper support for the hanging member. Additionally, by extending the projection 44 under the throw along the upending wall, the household object may be at least partially obscured. In this way, the current invention allows for obstruction of unsightly wires, cords or other household objects as desired.

FIGS. 2 and 4 also illustrates the hanger receivers 50, which in the illustrated embodiment are spaced longitudinally along the throw 20 for positioning a plurality of the hanging clips 40 along, one at each receiver 50. The hanger receivers 50 may be predrilled or punched holes at spaced intervals. Additionally, the hanging clip 40, may be designed with shapes having alternative or complementary shaped structures (not shown) for receipt by the hanger receivers 50 such as, but not limited to, a convex projection or an irregular projection illustrated in FIG. 4a with the alternative clip 140. The hanging clip 40 may have a variety of configurations and as indicated with the alternative clip 140 may even be fanciful for supporting the hanging member upon the improved ran guard 10 at the hanger receivers.

The rain guard 10 should be relatively inflexible to withstand the stress of installation and the ambient environment including rain, sleet, hail or snow. In addition, the rain guard 10 should be able to support the hanging member extending therealong and be able to handle moist environments. As such the rain guard 10 may be fabricated from rigid plastic such as polyethelyene, polypropylene, polybutylene, silicone plastics or ethylene propylene diene monomer (EPDM) or metals such as aluminum and steel or other known materials which are suitable for the specified use. The clip 40 and alternative clip 140, likewise, should be fabricated from similar materials for the same reasons, to withstand a moist environment while being generally rigid for use in supporting the hanging member.

FIGS. 3, 4, 4a and 6 illustrate substantially planar body 116 with a plurality of perforations 52 to create a mesh-like surface through which water is permitted to pass while limiting any falling debris from the trough 32, which transports any liquid from the roof structure 2 into the trough 32 and away from the building structure. The density of the perforations 52 may be designed to limit flooding and overflow of the planar body 116 while providing adequate surface flow to clear debris from the trough and the perforated planar body 116. The perforations 52 also permit air flow through and around the debris that might settle on the perforated planar body after a rain storm. Air circulation through the perforated planar body and around the debris may evaporate surrounding moisture and facilitate removal of the dried debris off of the cover, thereby cleaning the substantially planar body 116. In this manner, the perforations 52 facilitate simultaneous cleaning of debris and removal of moisture off the roof structure 2 into the trough 32 of the gutter 40.

The perforated planar surface 116 also includes a backing 29 which is positioned between the gutter 30 and the fascia 4 or other vertical building structure. The backing 29 being generally normal to and dependent from the perforated planar surface 116, helps to secure the perforated planar surface 116 over the gutter 30 during use and removal for cleaning of the gutter with integrated hanger 40 as desired Alternatively, the backing 29 may be angularly oriented to the perforated planar surface 116.

FIG. 6 illustrates the underside of an alternative embodiment of the hanging clip 240 being formed from the upending wall 22. A horizontal projection 244 extends rearwardly from the upending wall 22 with a vertical projection 246 angularly extending from the horizontal projection 244 at a generally acute angle. A notch 250 is presented in the upending wall 22 generally complementary to said hanger 240. The hanging clip 240 allows for hanging household objects longitudinally along the upending wall 22 without puncturing the outer surface of the throw 20 and providing at least partially obscuring the visibility of the hanging clip 240 and received household object and as illustrated in FIG. 6 is completely hidden from view. A plurality of fasteners 54 are shown extending through the planar body 16 into the support ledge 24 in FIGS. 2-4a, with an alternative threaded fastener depicted in FIG. 6 for securing the front of the improved rain guard 10 to the front face of the gutter 30.

FIG. 7 illustrates another alternative embodiment of the rain guard 110 which includes a built-in trough which may be used in new guttering installation, for example when an installer can fabricate a new rain guard on site. The rain guard 110 includes a rear edge 137 extending upwardly and turning downwardly at an alternative rear wall 136, extending horizontally therefrom at the bottom 131 and then rising vertically at a front wall 138, a trough 132 presented thereby. An alternative support ledge 124 extends angularly from the alternative front wall 138 down to the upending wall 22 presenting the throw 20 and shoulder 118. The hanger 40 may receive the throw 20 or hanger receivers 50 may be provided spatially along the throw 20 as desired for the received hanger 40.

It is to be understood that while certain forms of the present invention have been illustrated and described herein, it is not to be limited to the specific forms or arrangement of parts described and shown. For example, the shape of the hanging clip can be changed according to the whims of the manufacturer. For example the invention may use a hanger that looks like a known geometric shape or design or may utilize various colors. Additionally, the utilized gutter may include the variety of known gutter designs in connection with the present invention. All such modifications and alternate embodiments are intended to be covered by the scope of the claims presented below.

1. An improved hanging rain cover adapted for directing moisture received by a horizontal structure away from a vertical structure while hanging a house hold object, said improvement comprising:
a substantially planar body having at least one rib extending longitudinally therethrough;
said rib securing said improvement to said horizontal structure;
a shoulder contiguous with said substantially planar body and presenting a downwardly depending throw whereby moisture is directed from said horizontal structure by said substantially planar body and angularly away from said vertical structure by said throw;
at least one receiver extending through and spaced along said throw for receiving a hanger; and
said hanger presenting a projection for receiving the house hold object whereby said house hold object is at least partially obscured by said throw in receipt of said hanger.

2. An improved hanging rain cover adapted for directing moisture received by a horizontal structure away from a gutter having a rear wall spaced from a front face by a trough while hanging a house hold object, said improvement comprising:
a substantially planar body at least partially covering said trough;
said substantially planar body being secured to said front face,
a shoulder contiguous with said substantially planar body and presenting a downwardly depending throw whereby moisture is at least partially diverted from said trough by said substantially planar body and angularly away from said front face by said throw; and
at least one removable hanger received by said throw, said hanger presenting a projection for removably receiving the house hold object whereby said house hold object is at least partially obscured by said throw.

3. The improved hanging rain cover of claim 2 wherein said hanger is received by a receiver extending through said throw.

4. The improved hanging rain cover of claim 2, said hanger further comprising an upending arm.

5. The improved hanging rain cover of claim 2, wherein said substantially planar body includes a plurality of perforations.

6. The improved hanging rain cover of claim 2, said hanger further comprises a top clamping member and a bottom clamping member whereby said top and said bottom clamping members are inwardly biased.

7. The improved hanging rain cover of claim 6, wherein said top and bottom members are frictionally received by said throw.

8. The improved hanging rain cover of claim 2 further comprising:
an upending wall extending substantially coplanar with said throw;
a generally horizontal support ledge angularly extending from said upending wall and at least partially supporting said substantially planar body;
a backing extending vertically from said support ledge spacing said throw from said front face; and
a channel extending longitudinally between said throw and said upending wall.

9. An improved hanging rain cover adapted for directing moisture received by a horizontal structure away from a gutter having a rear wall spaced from a front face by a trough while hanging a house hold object, said improvement comprising:
a substantially planar body having at least one rib extending longitudinally therethrough, said substantially planar surface at least partially covering said trough;
said substantially planar body being secured to said front face, a shoulder contiguous with said substantially planar body and presenting a downwardly depending throw whereby moisture is at least partially diverted from said trough by said substantially planar surface and angularly away from said front face by said throw;
an upending wall extending substantially coplanar with said throw; and
at least one hanging clip presenting a rearward projection from said upending wall and removably receiving the house hold object whereby said hanging clip is substantially obscured by said throw and said house hold object is at least partially obscured by said throw.

10. An improved hanging rain cover adapted for directing moisture received by a horizontal structure away from a gutter having a rear wall spaced from a front face by a trough while hanging a house hold object, said improvement comprising:
a substantially planar body having at least one rib extending longitudinally therethrough, said substantially planar body at least partially covering said trough;
said substantially planar body being secured to said front face,
a shoulder contiguous with said substantially planar body and presenting a downwardly depending throw whereby moisture is at least partially diverted from said trough by said substantially planar body and angularly away from said front face by said throw; and
at least one hanger received by said throw, said hanger presenting a projection for removably receiving the house hold object whereby said house hold object is at least partially obscured by said throw.
